(19) United States
(12) Patent Application Publication
(10) Pub. No.: US 2010/0055270 A1
(43) Pub. Date: Mar. 4, 2010

(54) Method and process for the controll of water weight loss in spray chill operations with the subsequent reduction of airborne bacterial load in air utilizing specialized chemistry in an air wash system in protein-based food processing plants

(75) Inventors: Battle B. Glascock, Soddy Daisy, TN (US); Robert C. Bullard, Signal Mountain, TN (US); James A. Faller, Signal Mountain, TN (US)

Correspondence Address: DOWELL & DOWELL P.C., 103 Oronoco St., Suite 220, Alexandria, VA, 22314, US

(73) Assignee: Zee Company, Signal Mountain, TN (US)

(21) Appl. No.: 12/457,420

(22) Filed: Jun. 10, 2009

Related U.S. Application Data
(60) Provisional application No. 61/129,199, filed on Jun. 10, 2008.

(51) Int. Cl. A23B 4/14; F25D 17/06; A23B 4/08

(52) U.S. Cl. 426/332; 99/474; 62/176.4; 62/259.1

(57) ABSTRACT

It has been discovered that precise control of relative humidity within the Spray Chill rooms of meat processing facilities can help control carcass water weight loss. Through the use of a specially designed air wash system this loss can be controlled. As an additional beneficial effect of this process, it has been proven that a significant reduction of airborne bacteria can be seen through the application of proper air wash sump chemistry through the specialized process. Further to this development, and in combination with the proper sump chemistry humidifying system, continual cleaning of the process air and internal areas of the air handler as well as the filter and fill materials is seen, allowing for a continual cleansing of the system while delivering sanitized air and providing high room humidity for the control of water loss during the carcass chilling operation and the reduction of airborne bacteria in the spray chill room or any meat storage area.

### BACKGROUND OF THE INVENTION

1. Field of the Invention

The present invention relates to the control of water weight loss within a meat processing plant spray chill room and the control of bacteria within the same processing space.

2. Description of Related Art

Based on studies conducted by Sofos, 1994; Sofos et al. 1999, it was shown that animal products, including carcasses and fresh meat, are contaminated with microorganisms and support their growth if not properly handled, processed and preserved. Extensive contamination, or abusive conditions of handling and storage that promote microbial proliferation, increase the potential for the presence of pathogenic bacteria and formation of toxins, and may lead to product spoilage and public health problems. Further to this statement, a variety of sources, including air, water, soil, feces, feeds, hides, intestines, lymph nodes, processing equipment, utensils and humans, contribute to the microbial contamination of the meat products during slaughter, fabrication and further processing and handling. (Bell, 1997; Gill, 1998; Sofos; 1994)

Microbes of all kinds have a dramatic effect on the quality and safety of the food supply chain. They are naturally occurring biological organisms that must be taken very seriously by the food producer in order to maintain a safe supply of consumable goods. Each has its own characteristic morphology and biological activity. Microbes all have distinctive attributes as far as their effect on the food supply chain, with some beneficial, and some not so beneficial, contributions to animal and plant substrates. They are a major component of the natural biology on earth and can be found in various forms on the hides and in the storage pens of the meat processing facility. One of the primary and most dramatic influences microbes have in common is their potentially harmful effects to the food supply chain and more specifically, through their contamination of meat products as referenced above, to the human consumer.

Food poisoning affects some 60 to 80 million people each year resulting in approximately 8 thousand deaths in the United States alone. Salmonella alone cost approximately $1 billion a year in medical costs and lost time on the job, according to the Centers for Disease Control and Prevention. Food quality and food poisoning resulting from bacterial contamination of meat products are concerns shared by both food producers and consumers.

Due to the modernization of manufacturing and transportation systems, it is now possible to supply increasing demands for meat products from fewer, but much larger, manufacturing facilities. A pathogenic bacterial outbreak in one of these larger facilities could lead to a significantly large number of people exposed to the harmful effects of these very aggressive and harmful microorganisms.

A primary focus on this disclosure is the harmful effect these bacteria have on certain industries and processes, and a method by which their effects on food safety can be attenuated.

Avenues of entrance of bacteria into processing plants includes the animals themselves, either internally or externally and airborne routes.

Depending on the feeding practice by farmers and feed lots, where animals are briefly held prior to shipment to the processing facility, the diet of the animals can affect bacterial growth in their digestive tracts. This means that animals carry bacteria into the processing plant where removal—and exposure to the ambient air—of the intestines and stomach and their contents, occurs during processing. Careful control of this operation is required to ensure that cross contamination from the evisceration process to other parts of the plant is avoided.

In agricultural industries, and more specifically in the high output production of beef and pork, the control of airborne microorganisms, both inside and outside the processing facility, is of primary concern. Also one of the least investigated vectors in the potential bacterial contamination of meat products is air.

### Airborne Bacteria External to Processing Facilities

Processing facilities are strategically located to take advantage of available lands for the raising of livestock as well as to minimize transportation costs. They are designed to process large numbers of animals with extremely high efficiency. As a result of these high speed production methods, livestock are delivered to the plant on a daily basis from feed lots and large farms where they are temporarily stored in large holding pens or lots located just outside the processing plants. Because of the large concentration of animals, all contained in close quarters, the animal hides are covered with fecal mater and are perfect breeding grounds for microorganisms. The containment areas are covered in fecal matter as well, and thus support florid microbiological growth. Bacteria find the holding pens and stock yards a nutrient rich habitat for rapid growth and reproduction.

Air often contains microorganisms, but they do not live in the air. They are often attached to other small particles such as dried residues from water droplets, dust, soil or skin flakes. Due to evaporation of water, bacterial cells often die when they become airborne, but under high humidity conditions, their survival rates increase.

Airborne microorganisms are transported on air currents, and move quickly or slowly depending on the ambient air flow. Based on the large number of animals at the processing plant, and due in a large part to the containment means and its close proximity to the processing facility prior to processing, the volumes of airborne microorganisms may be very high. This is especially significant during high velocity cross-winds or high humidity conditions when bacteria can be rapidly dispersed and sustained by the food and moisture carried on the wind. The transport and distribution of these bacteria in the processing plant is of primary concern.

Processing plants currently utilize standard air conditioning and air make-up systems to supply and distribute air to and within the facility. It is inevitable that air from outside of the plant is allowed to enter the plant through open doors or through air conditioning systems. Air drawn in from the outside of the facility will transport with it the entire microbial population of the air.

A primary concern for food producers is to minimize or limit the number of microorganisms—especially pathogens—that invade the processing floor by concentrating on periodic cleansing and sanitizing of all contact surfaces, and by appropriate intervention treatments to the meat itself during processing. A primary focus of this disclosure is to identify a process by which the transport of airborne microorganisms into a food processing plant can be interrupted and/or attenuated.

### Airborne Microorganisms and Pathogen Sources Internal to Processing Facilities

The processing of protein-based food materials results in the generation of a very large organic soil load as part of the daily routine. Food processing facilities are under stringent mandates by Federal regulatory agencies to control the potential build up of pathogens within the processing plant and on the protein products being processed therein. Stringent countermeasures to any potential source or harborage of bacteria are routinely practiced, with processing line intervention sites and plant sanitation being significant parts of the daily routine.

Organic soils are generated throughout the facility as a by-product of the daily routine and are potential breeding sites for the development of pathogens and food spoilage microorganisms. The design of processing equipment is closely controlled, and wash down procedures are strictly adhered to, in an effort to prevent the outbreak of bacterial growth in any area of the plant or on the surface of the processed meat products. USDA personnel are on-site throughout the facility continually checking for contamination and have the ability to stop production if excessive contamination is found in any area of the plant. Because of the concern for the safety of the food supply, processing plants spend millions of dollars on prevention methods and strive to ensure an acceptably clean environment for the processing of protein-based products. Very little of this capital, however, is directed to the decontamination of plant air. Slight attention is given to this potentially large contributor to sporadic bacterial efflorescence.

In order to control bacterial colony establishment and growth, large volumes of potable water, as well as specialized chemicals and detergents, are used to clean the processing line equipment, plant floors and walls both during production and sanitation shifts. Water purifications systems, using various sterilizing methods and chemicals to achieve potability, make up a large percentage of the operating cost of the facility. Use of on-line, intermittent chemical intervention sites allows for repeated destruction, but not elimination, of bacteria introduced into the plant. Frequent training of plant personnel in proper product handling and personal hygiene techniques is designed to minimize recontamination by humans of the protein products as they are processed.

No matter the extent to which a plant goes to eliminate pathogenic materials from the processing facility, it is almost impossible to completely kill all of the undesirable microorganisms in the plant and on meat products without altering the organoleptic qualities of the processed meat. This failure to kill is evidenced in periodic increases in microbial surface contamination of the processed meat as it is carried through the production facility. As stated previously, the residual bacteria on the surface of the meat may effloresce if allowed enough time and given the proper growth conditions.

### Prior Art

Historically, the methods used to control harmful bacteria within the high volume processing facility have been based on a surface contact approach. A majority of the new technologies available have been applied directly onto the meat products being produced, as well as to the machinery surfaces and plant walls and floors that are subject to microbial build-up. These application or intervention sites generally utilize water-based chemistry to minimize microbiological growth, and do so very well considering the potential for pathogen growth on the materials being processed. Even with all of the sanitizing efforts and a very high kill rate, there are still unexplainable intermittent microbial outbreak events within the production facility.

Typically, the control of airborne pathogens has involved one or more of three control methods. Increased ventilation, negative pressure isolation of a given processing room, and filtration systems are typically applied to food processing facilities as they would be in less stringently controlled industries.

The newly discovered process as outlined below provides very effective air control to not only reduce airborne bacteria but also reduce water weight loss of the carcasses. The air control process delivers high relative humidity to a defined space, doing so in a way that allows human access to the space during treatment, and controls the evaporation rate from the carcass. One beneficial aspect of this process is that airborne bacteria are continually exposed to antimicrobial chemicals as room air flows through the system, providing an effective means to help control bacterial growth on meat products. Another beneficial aspect of this process is that water weight loss due to evaporation is reduced in the carcasses.

### Water Weigh Loss Due to Evaporation

One area of the facility that allows for relatively long-term storage between interventions is the Spray Chill room. This is the area of production where the core temperature of the carcass is brought down to just above freezing, where it will be kept throughout the remainder of production. The carcass is delivered to the spray chill room just after leaving the slaughter and disarticulation area, and having had applied various chemical or mechanical interventions which are designed to reduce microbial populations on the surface of the carcass. The carcass now enters the Spray Chill room.

The term “spray chill” describes the method by which carcasses are chilled in the Spray Chill room. That is, as they transit this room, they are sprayed with cold water, both to promote carcass cooling and to help prevent water weight loss during chilling. The Spray Chill room is usually maintained at approximately 35° F., and the carcass is allowed to remain in this room for an extended period of time, until its core temperature has equilibrated with the room air temperature. Previous methods of chilling did not involve a spray application and the water weight loss in the carcass was significant. Spray chilling allows the carcass to cool faster due to the higher heat transfer rate of water over that of air-only chilling, but excessive application of water on the carcass surface has a detrimental affect on the meat surface appearance and texture, if misapplied.

Detection, monitoring and control of room air conditions are usually minimal with, typically, the only control feedback being temperature. The time required to bring the carcass down to room temperature is fairly significant. Based on the large production rate of the processing facility, and the time required to bring the carcass temperature down, there could be as many as 10,000 carcasses stored in the room at any given time.

Due to the large size of the rooms, and as a result of the chilling process taking place, it has been very difficult, if not impossible, to maintain proper atmospheric conditions within the space to prevent the evaporation of water from the carcass surface. The financial cost of water weight loss to the producer is significant and the quality of the meat is often affected by uncontrolled water loss.

Another necessary but detrimental effect of this carcass cooling process is the length of time it must remain in the room before it encounters another intervention site for the control of bacterial growth. It is in this space that the carcass is subjected to airborne microbes that are carried throughout the plant by air infiltration from the outside. Attempts have been made to add chemicals to the spray water to reduce the bacterial growth on the carcass, but because the room sustains frequent human traffic, the concentrations of the chemicals must be maintained at such a low level that antibacterial effectiveness is minimal.

Water loss from the surface of the meat in the Spray Chill room results from several factors, explored below.

### Relative Humidity

Relative humidity is a term which indicates the amount of water vapor that the air can hold at a given temperature and pressure. Air in the atmosphere is comprised of many different gases, but the major constituents are Oxygen, at twenty-one percent, and Nitrogen, at seventy-nine percent, plus water vapor, along with other trace amounts of gases that will not be considered here. When discussing and working with relative humidity in a given atmosphere, it is important to know some basic terminology that defines the science. Humidity is simply water that is in a gaseous phase and is referred to as water vapor. It is frequently desirable to describe how much of the ambient air is comprised of water vapor.

Because water vapor exists as a gas in air, we can apply most of the common physical gas laws to analyze the total composition of the air. Dalton's Law states that the total pressure of a gas, in this case air, is equal to the sum of the partial pressures of each gas contained therein. Each gas contained in air contributes a portion of the total pressure, or partial pressure. All of the gases additively make up the total pressure.

Dalton's Law=Pₜₒₜₐₗ=P₁+P₂+P₃ . . . +Pₙ

Considering the total air pressure at sea level as being standard conditions with a pressure of 14.7 psi, this total pressure is comprised of the partial pressures of Oxygen+Nitrogen+water vapor+all of the other trace amount gases contained in the air.

The temperature of the air will dictate what the maximum water vapor partial pressure can be, with the absolute maximum being when the air is totally saturated with water vapor. Tables have been written which detail what the saturated partial pressure of water vapor is for a given temperature. As the temperature of the air rises, the saturation partial pressure of the water vapor increases. Thus, warmer air can contain more water vapor than cooler air. In order to graphically define the relationship between temperature and the water saturation vapor pressure, a very useful tool referred to as a psychrometric chart has been developed. Because air at a given temperature can be completely saturated with water vapor—one hundred percent relative humidity—or can contain as little as none at all—zero percent relative humidity—the various conditions of air with the relative amounts of water vapor contained therein are shown on the psychrometric chart to aid in the determination of relative humidity.

Relative humidity may be expressed in equation form like this:

Relative Humidity=(P_{gas}/P_{saturated})(100)

In simplified terms, relative humidity is the ratio of the actual partial pressure of the amount of water vapor in the air to the partial pressure of the water vapor at saturation at that same temperature and pressure.

Evaporation from the Carcass Surface Based On Relative Humidity

One hundred percent relative humidity means that the air is saturated and it cannot hold any additional moisture. If a volume of water is located in a room which has one hundred percent relative humidity and the volume of water evaporates into the air, an equal amount of water vapor in the air must be condensed out before this evaporation can take place. Any relative humidity lower than one hundred percent means the air can absorb additional moisture from a liquid surface located within the space until the relative humidity of the air reaches one hundred percent.

When air has a relative humidity of one hundred percent, the partial pressure of the water vapor in the air is equal to the surface pressure of any liquid surface located in the space. If the partial pressure of the water component in the air equals the surface pressure of the liquid in the space, water is not evaporated, the volume of water remains intact, and water loss from the ambient water volume does not take place.

When the relative humidity in the Spray Chill room is less than one hundred percent, evaporation from the surface of the carcass located in the space will take place. If the room were maintained at one hundred percent relative humidity, no water would evaporate from the carcass surface and therefore the carcass would not lose any water weight. Although this condition would eliminate water loss from the carcass altogether, one hundred percent relative humidity would cause a much larger problem for the meat producer. Maintaining one hundred percent relative humidity in the Spray Chill room means that the dew point—the temperature at which water condenses from the air—is equal to the air dry bulb temperature—the temperature read on the room thermostat. Any surface that has a temperature equal to the dew point or is at a slightly lower temperature, will condense water droplets onto that surface. When the surface is horizontal and over meat products, condensation droplets can rain down on the meat, potentially causing significant bacterial contamination of the meat.

The key is to maintain relative humidity in the space low enough to prevent condensation but as close as possible to one hundred percent to help prevent evaporation from the carcass surface.

### Spray Chill Room Cooling Systems and Humidity

Because of the extremely large size of the Spray Chill room, and the fact that most cooling systems used in this application do not have humidity controls incorporated into their design due to the capital cost of this feature, control of room humidity is left to the resultant humidity delivered by the chiller air handler. In order to attain the desired room set point temperature, the discharge air temperature of a given air handler is set lower than the room temperature. The discharge air temperature enters the room and the heat load within the space adds heat to the cold air, thus raising the effective temperature to the set point condition. Typically, the air delivered from a chilled coil air handler leaves the air handler at just about saturation, or nearly 100% relative humidity. When the discharge air leaves the air handler, it is heated by the room load thus allowing for a decrease in its relative humidity. If moisture is not added in sufficient volumes, the resultant air will have a relative humidity lower than saturation. This air will now have the ability to store moisture. Any liquid water located within the space, including that located on the surface of a carcass, will be subject to evaporation. Even though there are, typically, large volumes of water on the floor in the room, the air takes on moisture from all wet surfaces without discretion. Because of the large numbers of carcasses hanging in the room, and to the significantly larger (by comparison to the floor) surface area represented by these carcasses, more water is evaporated from the carcasses than from the floor. Depending on the refrigeration design, and its ability or inability to react to room loads, the relative humidity within the space will fluctuate wildly as the room load increases and decreases due to the number of carcasses hanging therein and by the heat load subjected on the building by solar and other atmospheric sources.

### Spray Chill Room Air Currents and Carcass Water Loss Due to Evaporation

When air currents are allowed to exist within the space, which are caused by any number of sources but primarily from the cooling air handlers servicing the room, the cross currents of air continuously impinge on the surface of the carcass promoting the evaporation of surface water when the relative humidity is below one hundred percent. As the water evaporates, it requires an input of heat equal to the latent heat of vaporization of water. In the Spray Chill room this latent heat is provided by the carcasses hanging therein.

As water evaporates from the surface of a carcass, a decrease in surface tension is seen, which provides a surface suction pressure on the internal water of the carcass. In an attempt to equalize surface and internal pressure, water is drawn from the inner portions of the carcass to replace water evaporated from the surface. The higher internal temperature of the carcass, especially during the initial 8 hours of storage in the Spray Chill room, drives this process because water at the higher internal temperature is at a higher pressure than the partial pressure of the cooler atmospheric water vapor. So water loss in the carcass is higher at the first 8 hours of chilling than at the end of the process as the carcass begins to cool down. This has been well documented in the industry.

When plant operational personnel take humidity readings in the Spray Chill room, the moisture contained in the air is derived primarily from the hanging carcasses, and secondarily from the water spray operation. The water spray operation is an ineffective means of increasing room relative humidity because most of the water sprayed falls to the plant floor and is carried to the floor drain. The room relative humidity readings may indicate a high humidity but, if the carcasses were removed from the room and replaced by a dry heat load equivalent to that generated by the carcasses, the actual relative humidity in the space would be much lower. This water removed from the process air stream must be replaced by some means other than the water contained within the carcasses.

Ideally, the means by which the air moisture is provided must be designed to minimize microbial transport on air currents throughout the room to help maintain low bacterial loads on the carcasses, and to help avert potential unexplainable microbiological outbreaks that may compromise food safety or quality.

### OBJECTIVES OF THE INVENTION

With these considerations in mind, it is critical that a system be designed to provide the following objectives and features;
1) The system should be able to add moisture to the air in the room in amounts necessary to maintain a high relative humidity to prevent the evaporation of moisture from the carcass without driving the room humidity to one hundred percent.
2) The system must be able to help prevent the creation of a microbial harborage on the system fill or filter media.
3) The system must provide ample air turnover to maintain the highest possible room humidity without reaching saturation while reducing airborne bacteria delivered to the plant from the outside.
4) The system must be compact enough to allow placement in an existing facility without being mounted on the floor or obstructing the plant operations in any way.
5) The system must not increase the air flow currents within the space that would cause air to flow across the surface of the carcass thus promoting water evaporation.
6) The system must not discharge harmful chemicals or odors that would prevent human access to the space.

### SUMMARY OF THE INVENTION

In order to meet the design criteria discussed above, a novel and unique method for treating ambient air in the Spray Chill room has been developed which includes the following desirable features:
1) Relative humidity in the room is maximized to prevent water loss from hanging meat while preventing potentially harmful condensation.
2) An antimicrobial agent is used to minimize bacteria being transported on air currents in the room
3) The chemistry used in this application does not harm the meat products or interfere with the ability of humans to traverse or work in the treated space

### Process Air Handler

The equipment utilizes a specially designed air processing system combined with an antimicrobial chemical formulation that is sprayed onto the surface of a specific filter or fill medium to effect the efficient evaporation of water while providing microbiological control of the ambient air. A system specific chemical feed and treatment system designed to continually control the chemical concentration within the feed piping prior to spraying the liquid media onto the evaporation fill has been designed and incorporated. The chemical feed system features the ability to moderate the temperature of the chemically treated water in the system, allowing for an increase in the air handler discharge humidity if called for by the room set point humidistat.

The system is quite novel in this application and use in that the air forced through the porous fill medium is continuously washed by an atomized mixture of water containing an antimicrobial chemical. As the air flows through the high-surface-area fill medium, it evaporates the moisture from the fill surface, thereby increasing its relative humidity as it exits the system.

Depending on the relative humidity of the incoming air stream, the amount of moisture evaporated from the surface of the fill will vary based on the fill efficiency. During the process, residual water that is not evaporated into the air stream is collected in a sump reservoir where it is carried back to the chemical injection system for filtering and reprocessing to maintain the antimicrobial chemical concentration and to remove any solid material dropped from the air stream. System efficiency is rated by the ability of the system to bring this collected water temperature as close as possible to the entering air wet bulb temperature.

In order to increase the amount of evaporation from the units, heat is added to the incoming process water stream which drives the system efficiency up, meeting the set point conditions within the space. The supplemental heating of the process water is only required when the relative humidity of the room decreases, for one reason or another, ensuring that the system operates in a very efficient manner, with natural evaporation providing a majority of the humidity control.

The following equations can be used to predict the discharge conditions of the air with fairly high precision when the inlet water temperature and the inlet air properties are known.

### Given:

### P=Pressure

### H=Enthalpy

### M=Mass Flow Rate

### Subscripts:

a=air
g=gas
v=partial pressure of water
w=water

### 1=Inlet

### 2=Outlet

### Equations:

w=Humidity Ratio=0.622(Pv/(P−Pv)) (1)

F=Relative Humidity=Pv/Pg (2)

Conservation of mass=w1Ma+Mw=w2Ma (3)

Conservation of energy=Ha1+w1Hg1+(w2−w1)Hw=Ha2+w2Hg2 (4)

The saturation pressure of water vapor at a given temperature is available in table form as stated previously, and so we can use the equations given above to calculate what the discharge conditions of the air will be if we know the room conditions at the inlet, the amount of water that is evaporated from the sump during a given period of time, and its residual temperature.

These calculations are most useful in calculating system efficiency, that is, the water volume that is consumed in the process over a given period of time. The more water evaporated, the higher the efficiency and thus the closer the discharge air conditions will be to saturation in an adiabatic operation. By increasing the water evaporation rate, the mass flow rate, Mw given in equation (3), will yield higher w, or humidity ratio. By utilization of equations (1) and (2), and solving for F, or the discharge relative humidity, it can be seen that the desired goal of increasing the discharge air relative humidity and the system efficiency can be achieved.

These same formulae accurately calculate the volume of water that is delivered to the discharge air stream for use in the Unit Selection Method described below.

The process air handler detailed above is only a part of the overall system. In order to utilize this method of preventing water weight loss in the carcass without contributing to the bacterial load within the space in any way, it is imperative that the water circulation system, which is used to continuously recirculate water through the air handlers, not sustain bacterial growth. Because water and the organic debris dropped from the air in a food processing plant may create a rich growth medium for bacteria, it is desirable to treat the water circulation system with an antimicrobial chemical to minimize bacterial growth and dispersion potential through the processed air stream.

### Unit Selection Method

In order to properly size the number of air handling units for a given room, the parameters used for system design must be calculated. The determination of how much water is being removed from the space in any and all forms, so that the same amount can be added back by the new system, requires a free body analysis of the room and all operations taking place therein. Various processes add water to the room and others take water away. The primary goal of this analysis is to determine how much water is being taken away in vapor form so that compensatory water vapor can be added. The new system must also add to that amount enough water vapor to maintain the room relative humidity at ninety to ninety-five percent to prevent natural evaporation from the carcass surface.

In order to maintain low storage temperatures in an existing spray chill room, refrigeration air handlers with cooling coils are placed throughout the space, typically at ceiling level. These refrigeration air handlers take air from the room, cool it down with subsequent condensation of water from the air in the cooling coil, and discharge the cooled air back into the room at a temperature that is lower than the room set point as described above. This is a natural cooling operation, and condensation from the coil, especially in cool, high humidity environments, always occurs. The in-house cooling system continuously depletes water vapor from the room, negatively impacting the ability to maintain a high enough relative humidity to help prevent carcass drying.

Typically, the room relative humidity is lower than the desired level of ninety-five percent because processing plants use standard chilled coil refrigeration in virtually all cases. The rooms are not enclosed and are subject to infiltration and cross winds from other, warmer areas of the plant. Maintenance of a high humidity level in a fairly open space is impossible without a very aggressive humidification system in place. Use of a spray chill system represents an effort to provide additional humidity into the space, but a majority of the water supplied never makes it to the vapor state and simply falls to the floor and is carried away in the plant drains. If a high relative humidity is able to be maintained in a room, the humidity is being provided by either evaporation from the carcasses or by a very aggressive humidity injection system. If a spray chill room does not have a very aggressive humidification system in use, the humidity in the room can only be coming primarily from the carcass. The room is therefore, by design, a carcass drying system.

In all cases, there must be condensation coming from the refrigeration cooling coil in a spray chill room or it is not operating properly. If the cooling coil does not produce condensate, either the inlet air is very dry and the surface temperature of the coil is above the dew point of the inlet air or the coil is not cold enough due to a mechanical malfunction.

The refrigeration cooling coil can only cool the air. It does not humidify. But it does raise the relative humidity of the discharge air as compared to the inlet air. The reason for the rise in relative humidity is that the temperature of the air is being lowered, resulting in a higher temperature RELATIVE humidity. Water is removed from the air but the relative humidity goes up. The amount of water vapor in the discharge air and its relative humidity is based on its new, lower temperature. The relative humidity may be measured as being higher but, in fact, the actual moisture content is lower than that of the plant air.

Because the air handler is condensing water at all times, and the discharge air is at a lower temperature than the room set point, the air leaving the air handler is at, or just below, saturation. Because the discharge air is cooler than the room air, and because it will inevitably be reheated in the room to the set point or higher, the resultant air will have a relative humidity that is much lower than the desired ninety to ninety-five. Again, the system is a very effective drying machine.

The condensation of water from air in refrigeration air handlers—as well as the difference in the actual room relative humidity and the desired relative humidity—when multiplied by the room volume, will yield an indication of the amount of moisture that must be added to the space by external means to prevent water evaporation from the carcass surface. Tests have shown that if the room relative humidity is continuously maintained at approximately ninety to ninety-five percent relative humidity, water weight loss in the carcass is dramatically reduced.

Making these field determinations of water vapor requirements is difficult and could possibly disrupt the production process. As a part of the disclosure, a novel method for determining the required volume of moisture that the air handlers will need to add to the space is disclosed.

By taking the average weight of a carcass and determining what the total average water weight loss is for each carcass—numbers that the processing plants tracks continuously—a simple calculation of the total amount of water being evaporated can be made. Added to this number is the amount of condensation that is being generated by the air handling systems in the room and then the total volume of water vapor is known. This is used to calculate, with equations (1), (2), (3) and (4) above, the total air flow rate and thus the total number of air handling systems a room will need.

Knowing the total air flow rate allows for precise control of room relative humidity, thereby directly affecting the evaporation rate of water from the carcass surface and the overall water weight loss from the carcass. Utilizing the total air flow rate to design the proper air handling system(s) will result in an even distribution of air throughout the space, while maintaining a relative humidity that can be effectively controlled to prevent water weight loss from the carcass.

### Chemical Feed System

This feature of the disclosure describes another very beneficial element to the overall system design in that the air that is circulated in the room now has a means by which it can be filtered and sanitized. Never before has this type of air sanitizing system been available to the meat processing industry.

As discussed above, the meat processing industry, like most other manufacturing plants with similar needs, utilizes one or more of the three air filtration methods for lessening the potential of bacterial contamination. None of these available systems provides an in-plant air sanitizing system that continuously treats air in a recirculating fashion as an intervention method for the control of bacteria in plant air. All other available systems pull air from the plant to the outside of the building and treat it as it is discharged to the atmosphere. This requires that the air removed from the plant be replaced with an equal volume of air by some other supply source. This make-up air volume, especially when derived from the exterior environment of a meat processing plant, is potentially heavily laden with bacteria which, left untreated, could compromise both food quality and food safety inside the plant. Because of this potential, this type of system is typically not utilized in a meat processing facility.

The disclosed process continuously circulates plant air, within a specific room or defined enclosed space, to effect the destruction of airborne bacteria while providing a necessary increase in relative humidity for the control of water weight loss. The system can be employed in other areas of the facility if the desire is only to help minimize the bacterial load in air.

In order to provide these novel and beneficial attributes, the chemical feed system must provide a constant concentration of chemistry to the air handler. The chemistry will continually be degraded as it comes into contact with bacterial and other organic material in the air. The water portion of the system will also be evaporated out at a differing rate, altering the concentration inside the process. It is due to these operational facts that the water and chemical mixture cannot be allowed to recirculate inside the air handling system as in a typical air wash system but must cycle only once and then return to be filtered and retreated to bring the antimicrobial chemical concentration back to the desired level.

As a component part of the overall disclosure, the complete system will include, along with the specialized air treatment system, a chemical filtering and injection system with system pumps to supply properly diluted antimicrobial chemical to each air handler in a given space. As well, return pumps remove excess liquid that is captured in the bottom sump of each air handler for return and filtering prior to being recirculated back to the air handler for reuse. The chemicals used in this particular application are based on a specialized mixture of Acetic Acid, Hydrogen Peroxide and Peracetic Acid. These compounds have been used in the meat processing industry for direct application to carcasses and meat parts in intervention sites throughout the plant, as well as for hard surface sanitizing. Sanitizers and intervention products based on these chemicals have proved to be very effective in reducing bacterial growth on surfaces and meat products within the facility. Application of these chemicals in this process is designed to be compliant with regulations and guidelines set forth by Occupational Safety and Health Administration (OSHA) as well as the American Conference of Governmental Industrial Hygienist (ACGIH). Each of these governing bodies designates safe concentration levels in air that humans breathe. OSHA specifies a Permissible Exposure Limit or PEL and ACGIH specify a Time Limit Value or TLV. Each is designated to limit the amount of time that a human can be exposed to vapors of certain chemicals.

The chemical composition that will be used can vary with the upper limits of the concentration being set by these guidelines. These current upper limits are as follows:

| | OSHA PEL | ACGIH PEL |
|---|---|---|
| Hydrogen Peroxide | 1 ppm | 1 ppm |
| Acetic Acid | 10 ppm | 10 ppm |
| Peracetic Acid | No Rating | No Rating |

Industrially, these chemical compounds are typically supplied in a drum or IBC tote. The chemical feed system is designed to monitor water flow rate in a given system and inject the antimicrobial chemical to a certain concentration level on a continuous basis. The water and chemical mixture is then delivered to the air handler where it is sprayed across the entire surface of the air handler fill material. Air is pulled across the fill and water is evaporated into the air stream where the chemical provides antimicrobial activity. As well, this activity occurs on the air handler fill itself. Residual water and chemicals that are not evaporated are captured in the sump of the air handler and pumped back to the chemical feed system. The returned water and chemicals are stored in a large tank where the total system water level is maintained by a water float system. Another supply pump pulls water and chemicals from the storage tank through a filter housing to remove any debris collected in the air handler. The chemical concentration level is checked by an inline concentration meter, and any additional chemicals required to bring the chemical concentration up to specified limits are added. The mixture is then returned to the air handler to complete the circuit.

If a return pump fails, the air handler has level controls located in the sump section to detect a low or high liquid level condition. This is also true for the primary chemical and water feed system, where main line water flow sensors detect if the main supply pump has failed. As an added feature to the system, located in the main supply line is an optional process water heating system that will be able to increase the process water temperature to support an elevation in relative humidity in the room as previously discussed.

The process is continuous and the chemical injection system ensures that the proper chemical concentration is used in the process.

### BRIEF DESCRIPTION OF THE DRAWINGS

The following is a brief description of some specific embodiments of the invention with reference being made to the accompanying drawings.

FIG. 1 shows the apparatus when used as a floor sanitizer.

FIG. 2 shows an exploded view of the apparatus.

FIG. 3 shows the apparatus when used as a pre feed system for the spray chill operation.

### DESCRIPTION OF THE PREFERRED EMBODIMENT

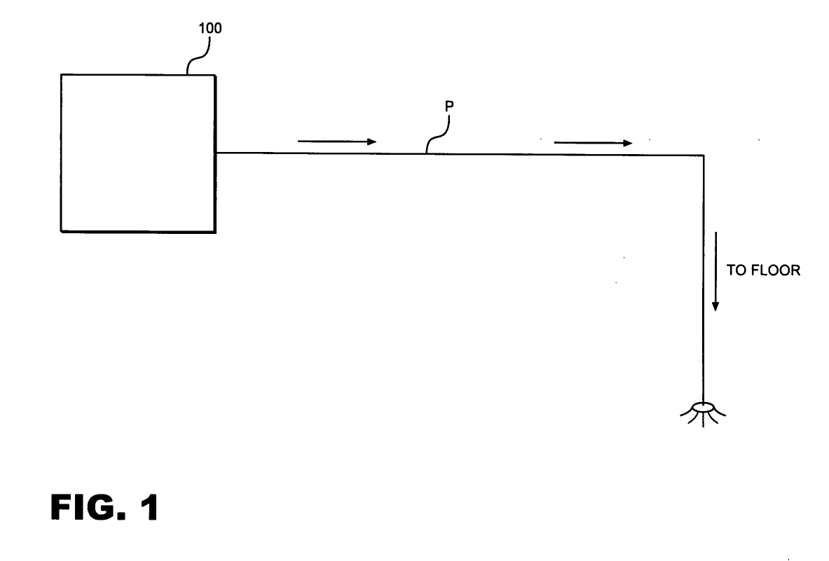

Referring to FIG. 1, the apparatus 100 delivers the fluid to the sump drain line 8. In this example, the drain volume emanating from the sump drain line 8 can be delivered to the plant floor and evenly distributed over the entire plant floor to assist in the control of floor located bacteria.

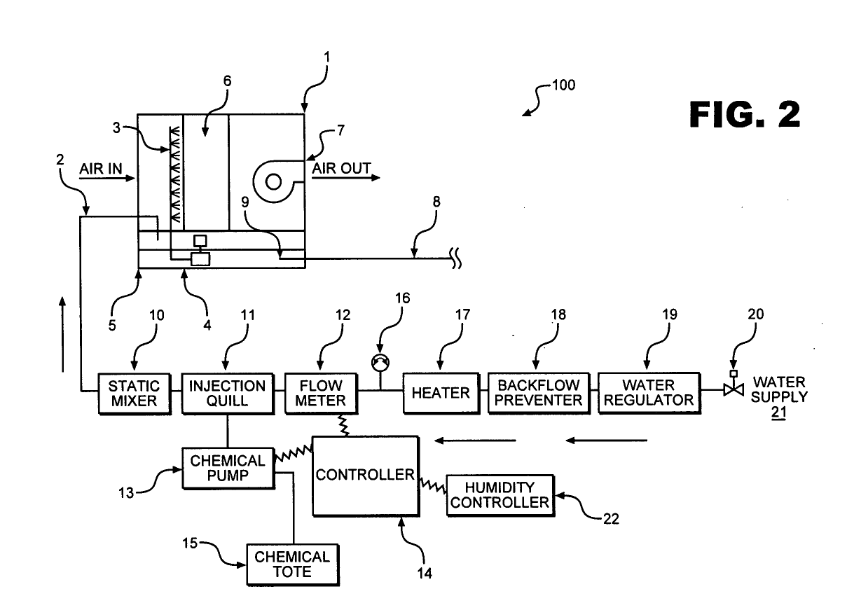

Referring to FIG. 2, the apparatus 100 consists of a primary air handling system 1 with a water and chemical supply line 2 positioned so that properly concentrated water and chemicals can be delivered to the chemical collection reservoir sump 5 and blended with the recirculation water and chemicals which are continuously circulated in the air handling system 1. The recirculation piping header 3 is supplied with recirculated water and chemicals by the recirculation pump 4 which is submerged below the line of the water and chemical mixture level of the water and chemical collection reservoir sump 5. The recirculated water and chemical mixture is mixed with the water and chemicals supplied by the chemical supply line 2 in the chemical collection reservoir sump 5 and the resultant mixture is sprayed onto the surface of the high surface area system fill material 6. Plant air is pulled through the air handler by the main blower 7 through the wetted fill material 6 where the air is brought into close contact with the fill material 6 surface. The water and chemical mixture which coats the surface of the fill material 6 provides a sanitizing effect on the incoming air by the reaction of the peracetic acid portion of the chemical material. The water portion is evaporated into the air thus raising the relative humidity of the air volume. As the water and chemical material mixture is sprayed across the surface of the fill material 6, a portion of the water is evaporated into the air with the remainder of the chemical and water being allowed to drip down into the collection reservoir sump 5. The volume of chemical and water mixture that is supplied via the water and chemical supply line 2 minus the evaporated water in the air stream is allowed to drain from the collection reservoir 5 through a sump drain line 8. The sump drain line 8 is connected to an overflow drain intake 9 positioned to allow only excess fluid to be drained to the sump drain line 8. The overflow drain intake 9 continually removes the overflow water and chemical mixture in a volume equal to the water and chemical supply line 2 volumes minus the evaporated water volume. This volume of drain material will have sanitizing chemicals remaining in its volume that are at a desired concentration. This drain volume can be utilized in other areas of the operation to affect the microbial activity typically seen in a plant.

The water and chemical supply line 2 material is supplied by a specialized chemical feed system comprising of a main potable water supply line 21 connected to a main shut off valve 20 then to a water pressure regulator 19 then to a water back flow preventer 18. Located down stream of the back flow preventer 18 is a process water heater 17 which provides water heating to increase the room relative humidity if called for by the room humidity controller 22. In order to properly set the system line pressure to deliver the proper volumes, a line pressure meter 16 is positioned just down stream of the pressure regulator 19.

Chemicals are added to the potable water supply line 21 in proper proportions based on the water flow rate measured by a water flow meter 12 located just down stream of the pressure regulator 16. The water flow meter 12 is an analog meter that sends a proportional control signal to the main process controller 14 and to the chemical feed pump 13. The main process controller 14 receives this proportional control signal from the water meter 12 and is used as a data recording device for tracking chemical and water usage. The chemical feed pump 13 takes the analog signal generated by the water flow meter 12 and generates a pulse action that drives a pump head to pull chemicals stored in the chemical storage tote 15 and delivers a fixed amount of chemicals based on the water flow rate as determined by the water flow meter 12 to the injection quill 11 located downstream of the water flow meter 12. Water and chemicals are mixed in the static mixer 10 in constant proportions based on the chemical feed rate set on the chemical feed pump 13. The mixed solution of water and chemicals are then delivered to the process air handling system 1 via the chemical supply line 2.

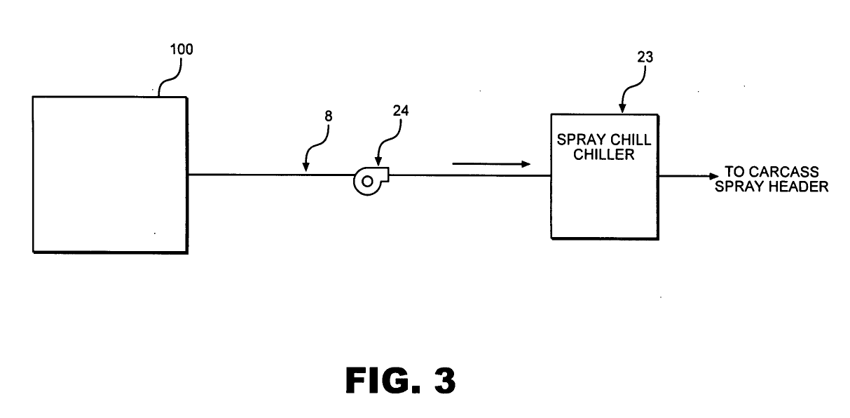

FIG. 3 shows an alternative embodiment with the delivery of the drain liquid from the sump drain line 8 being fed to the spray chill room chiller 23 via a delivery pump 24 for supply to the spray chill room spray header as is current practice for delivery to the carcass surface for sanitizing of the carcass surface.

We claim:

1. A method to control water evaporation from the surface of meat products in a room comprising the steps of:
generating a stream of air
treating air with water;
treating air with a chemical for reducing bacteria;
filtering treated air stream continuously to reduce bacteria;
controlling water content of air stream by adjusting temperature of water.

2. The method of claim 1, further comprising the steps of:
providing a high-surface-area fill medium
continuously spraying the high-surface-area fill medium with a mixture of water and antimicrobial chemicals.

3. The method of claim 2 wherein the step of filtering treated air stream includes passing the stream of air through the high-surface-area fill medium to reduce bacterial load in the air stream.

4. The method of claim 2, wherein the step of filtering treated air stream includes requiring only a single pass flow through of said high-surface-area medium to enable the water and antimicrobial chemicals to be constantly maintained at a specific concentration.

5. The method of claim 2, wherein the step of filtering treated air stream includes preventing the buildup of bacteria on an air handler.

6. The method of claim 2, wherein the step of filtering treated air stream includes imparting antimicrobial activity to the air stream.

7. The method of claim 1, wherein the step of filtering treated air stream includes adjusting the temperature of the water to increase the water content of the air of the room to meet set point conditions for the specific control of water loss in meat.

8. The method of claim 1, further comprising the step of minimizing the volume and flow of said water and antimicrobial chemicals.

9. The method of claim 1, further comprising the step of sanitizing the air stream in the room to reduce the total airborne bacteria in the room while maintaining the water content of the air stream in the room.

10. The method of claim 1, further comprising the step of continuously monitoring the concentration of the water and antimicrobial chemicals and adjusting a feed rate of the water and antimicrobial chemicals to match a pre-determined concentration of chemicals in the air stream.

11. An apparatus to control water evaporation and microbial contamination comprising:
a supply line for supplying a water and antimicrobial chemical mixture;
a water and chemical collection reservoir sump for collecting the water and antimicrobial mixture;
at least one recirculation piping header connected to said water and chemical collection reservoir sump for receiving the water and antimicrobial chemical mixture;
a recirculation pump for suppling the water and antimicrobial mixture to said at least one recirculation piping header;
a high-surface-area fill medium for contacting with the water and antimicrobial chemical mixture;
an air handler designed to cause an air stream for moving the air stream past said at least one recirulation piping header and said high-surface-area fill medium;
wherein the air handler moves the air stream past said at least one recirculation piping header and said high-surface fill medium to bring said air stream into contact with the water and antimicrobial chemical mixture to ensure said air stream is of a desired water content level and is relatively microbe-free.

12. The apparatus of claim 11 wherein said supply line is connected in series to a shut-off valve, a water regulator, a backflow preventer, a heater, a flow meter, an injection quill and a static mixer.

13. The apparatus of claim 11 wherein said flow meter is connected to a controller; said controller is connected to a chemical pump and a humidstat.

14. The apparatus of claim 13 wherein said chemical pump is further connected to said injection quill.

15. The apparatus of claim 13 wherein said chemical pump is further connected to a chemical tote.

16. The apparatus of claim 13, further includes a drain line for receiving the excess of the water and antimicrobial chemical mixture.

17. The apparatus of claim 16, wherein said drain line delivers the excess of the water and antimicrobial chemical mixture for distribution to the plant floor to assist with control of bacteria on the plant floor.

18. The apparatus of claim 16, wherein said drain line further includes a delivery pump for supplying the excess of the water and antimicrobial chemical mixture to the spray chill room chiller for sanitizing of the carcass surface.
